(19) United States
(12) Patent Application Publication
(10) Pub. No.: US 2003/0228125 A1
(43) Pub. Date: Dec. 11, 2003

(54) Method and system for fee-based commercial-free television viewing

(75) Inventors: Miroslav Trajkovic, Ossining, NY (US); Srinivas Gutta, Yorktown Height, NY (US); Antonio Colmenarez, Maracaibo (VE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/093,331

(22) Filed: Mar. 7, 2002

(51) Int. Cl. H04N 5/76

(52) U.S. Cl. 386/46; 358/908; 386/95

(57) ABSTRACT

A fee-based commercial television broadcast system is provided, wherein non-theatrical data is removed from transmission signals containing theatrical data and non-theatrical data. An input video signal is received by a video processing system. The input video signal includes information relating to non-theatrical images', such as commercials, beginning and end points, as well as the total length of such non-theatrical images in a particular program. A broadcast television service provider offers this information for a fee. This information is then used by the video processing system to enable real-time recording and delayed playback such that a user may view the program in one continuous block without non-theatrical data interruption.

### FIELD OF THE INVENTION

The present invention relates generally to a video signal processing, and more particularly to fee-based commercial-free viewing techniques for recording portions of broadcast programs or other types of video signals and playback thereof.

### BACKGROUND OF THE INVENTION

In commercial television broadcast, a significant portion of the broadcast time is devoted to advertisements for products, upcoming programming or station identification. For example, in the United States, network television broadcasts, product advertisements, i.e., commercials, are distributed within the theatrical portion of the broadcast regularly at 15-minute intervals. In some cases, the distribution of the theatrical image are more frequent, occurring, for example, at ten minute intervals.

Commercial and other non-theatrical interruptions, while needed to fund the production and transmission of television programs, become an annoyance to the viewer, as the same non-theatrical images are repeated in a single broadcast or, even, over multiple broadcasts of the same or different programs. The viewer is subjected to such a barrage of repetitive commercial content in order to impose the message upon the user.

Techniques for extracting commercials and other non-theatrical information items in a television broadcast are well known in the art. See, for example, U.S. Pat. No. 5,668,917, entitled, Apparatus and Method for Detection of Unwanted Broadcast, issued Sep. 16, 1997 to Lewine. Techniques disclosed therein may be used to remove all commercial and non-theatrical information from a received broadcast.

However, removing all commercials and non-theatrical information items is not advantageous since it is a significant source of revenue to service providers (i.e. free commercial television broadcaster such as ABC, NBC and FOX networks). Thus, there is a need to selectively filter non-theatrical information content from broadcast transmissions while allowing service providers to continue to generate revenue.

### SUMMARY OF THE INVENTION

The invention provides a fee-based television broadcast system by removing non-theatrical data from transmission signals containing theatrical data and non-theatrical data, e.g. audio/video information.

In accordance with the invention, a transmission signal, such as a television broadcast signal, is received, which includes non-theatrical identification information relating to the non-theatrical images', such as commercials. In particular, this information includes the beginning and end points of the non-theatrical images, as well as the total length of such non-theatrical images in a particular program. A broadcast television service provider offers this information to users for a fee. This information is then used by a video processing system to enable real-time recording and delayed playback such that a user may view the program in one continuous block without non-theatrical image interruption. Advantageously, the user may view other theatrical images, as well as previously recorded information, during period of playback delay.

According to another aspect of the invention, the techniques can be implemented in a fully automatic manner such that the video processing system modifies the television broadcast timetable, such as an Electronic Program Guide (EPG). In this manner a user can watch a program commercial-free without further interface or action.

Other features of the present invention will become apparent from the following detailed description considered in conjunction with the accompanying drawings.

### BRIEF DESCRIPTION OF THE DRAWINGS

FIG. 1 is a block diagram of a video processing system in which the invention may be implemented.

FIG. 2 is a diagram of a fee-based commercial broadcast process in accordance with an illustrative embodiment of the invention that may be implemented in the video processing system of FIG. 1.

It is to be understood that these drawings are solely for purposes of illustrating the concepts of the invention and are not intended as a definition of the limits of the invention. It will be appreciated that the same reference numerals, possibly supplemented with reference characters where appropriate, have been used throughout to identify corresponding parts.

### DETAILED DESCRIPTION OF THE INVENTION

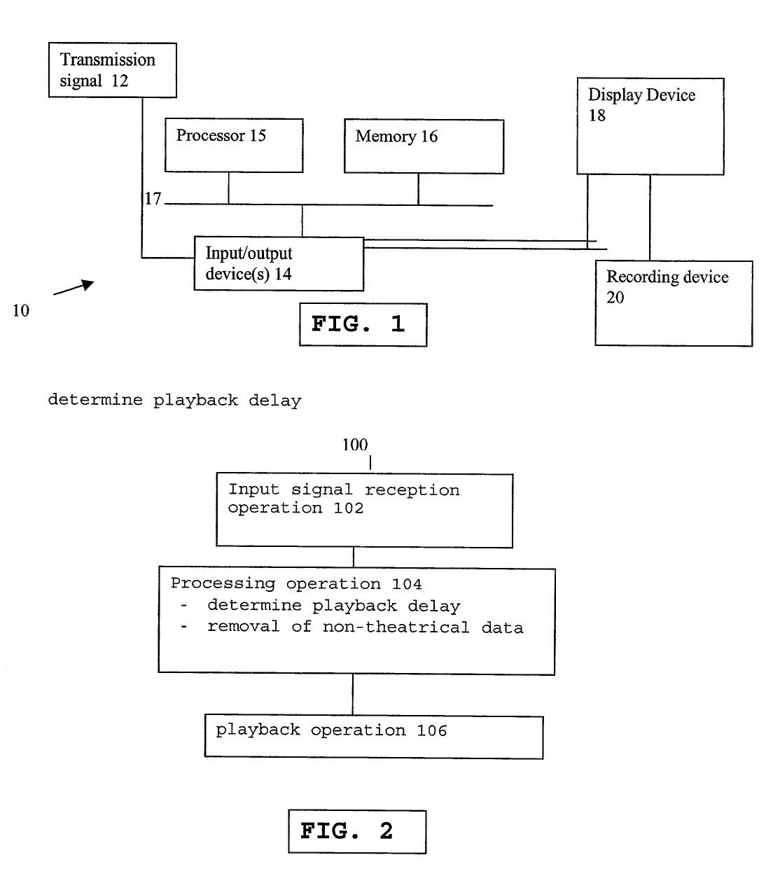

FIG. 1 shows a video processing system 10 in which the fee-based commercial broadcast techniques in accordance with the present invention may be implemented. As will be described in greater detail below, the system 10 may represent or incorporate a television, a set-top box, a desktop, laptop or palmtop computer, a personal digital assistant (PDA), a video storage device such as a videocassette recorder (VCR), a digital video recorder (DVR), an optical disk, magnetic disk or solid state based recorder such as a TiVO or ReplayTV device, etc., as well as portions or combinations of these and other devices.

The system 10 includes one or more video sources 12, one or more input/output devices 14, a processor 15 and a memory 16. The video source(s) 12 may represent, e.g., a television receiver, a VCR or other video storage device, or any other type of video source. The source(s) 12 may alternatively represent one or more service provider network connections for receiving video from a television network, server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks. The video sources provide a free commercial video signal that contains content a user wishes to view such as a theatrical presentation, programs, shows and the like, as well as a series of images not related to the theatrical presentation, such as advertising, commercials, news, weather, traffic, messages, which are generally interposed into the transmitted presentation image on a periodic or timed basis.

The input/output device(s) 14, processor 15 and memory 16 communicate over a communication medium 17. The communication medium 17 may represent, e.g., a bus, a communication network, one or more internal connections of a circuit, circuit card or other device, as well as portions and combinations of these and other communication media. Input video from the source(s) 12 is processed, e.g., in accordance with one or more software programs stored in memory 16 and executed by processor 15, or using dedicated hardware or firmware configured to operate in like manner, in order to generate output video which is supplied to a display device 18, which may be, e.g., a television display, a computer monitor, etc.

It should be understood that the particular configuration of system 10 as shown in FIG. 1 is by way of example only. Those skilled in the art will recognize that the invention can be implemented using a wide variety of alternative system configurations.

The present invention provides a fee-based television broadcast system by removing non-theatrical data from transmission signals containing theatrical data and non-theatrical data, e.g., broadcast programs received in the system 10 of FIG. 1, such that a desired program can be viewed in its entirety without commercial interruption with only an initial predetermined delay in the pre-scheduled broadcast time of the program. Advantageously, the techniques of the invention can be implemented in a fully automatic manner such that the video processing system modifies the television broadcast timetable, such as an Electronic Program Guide (EPG). In this manner a user can watch a program commercial-free without further interface or action.

FIG. 2 shows a diagram of an example fee-based television broadcast process 100 in accordance with an illustrative embodiment of the invention. The process 100 in this embodiment includes an input signal reception operation 102, a processing operation 104, and a playback operation 106. The process 100, in step 102 is applied to an input signal, e.g., input video which includes a given broadcast program to be recorded by recording device 20 of FIG. 1. In addition, the input signal contains non-theatrical identification information, which includes information relating to the non-theatrical data. Importantly, this information includes the beginning and end points of the non-theatrical data (e.g. a time period) or groups of non-theatrical data, such as commercials, in a particular program. In addition, this information may contain the total length of all such non-theatrical data in the program. A broadcast television service provider would offer this information for a fee. The fee may be charged using a monthly subscription or on a per program basis, which is accounted for in system 10. Thus, enabling an additional or alternate source of revenue to the service providers.

In the processing operation 104, input video received in system 10 is processed to remove the non-theatrical images from the particular program. The beginning and end points of such non-theatrical data in a particular program is used such removal. The resulting signal is recorded.

Alternatively, if only the total length of all such non-theatrical data in the program is provided, then conventional methods for commercial identification and removal may be used. The identification of commercials and other non-theatrical data are well known in the art. See, for example, U.S. patent application, Ser. No. 09/123,444, entitled, Apparatus and Method for Locating A Commercial Disposed With a Video Data System, filed on Jul. 28, 1998; and U.S. Ser. No. 09/417,288 filed Oct. 13, 1999 entitled Automatic Signature-Base Spotting, Learning and Extracting of Commercials and Other Video Content by Dimitrova, McGee, and Agnihotri, and U.S. Ser. No. 09/123,444 filed Jul. 28, 1998 entitled Apparatus and Method for Locating a Commercial Disposed Within a Video Data Stream by Dimitrova, McGee, Elenbaas, Leyvi, Ramsey and Berkowitz, the entire disclosures of which are incorporated by reference.

However, this alternative method has its limitations. For example, commercial detectors are not always precise, and portions of commercials may not be detected and portions of theatrical programs may be detected as commercials. In addition, measures may used to defeat such commercial detectors, for example, commercials may be created such that they are indistinguishable from theatrical programs (e.g. movies), and therefore commercial detectors would fail. Portions of the input video, such as the non-theatrical data, may be cached or otherwise stored in an appropriate storage device, e.g., a hard disk or other storage device associated with memory 16, recording device 20 or other element of system 10. For example, using a conventional hard disk recording device, the non-theatrical data may be stored for later viewing.

Referring again to FIG. 2, the resulting signal generated using the above-described technique is then used in the playback operation 104. Thus, enabling the direct viewing of the particular program with only a predetermined delay (as provided in the input signal by the service provider or estimated), due to the exclusion of non-theatrical images from the input signal stream. Alternatively, a user may select to view a different theatrical presentation, during such a delay period.

According to another aspect of the invention (not shown), the techniques can be implemented in a fully automatic manner such that the video processing system modifies the television broadcast timetable, such as an Electronic Program Guide (EPG). The EPG, for example, is re-formatted in with the appropriate delay in the scheduling display. This is conducted according to the particular specifications of the EPG in a conventional manner. Consequently, a user can watch a program commercial-free without further interface or action.

The following merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, and the like represent various processes which may be substantially represented in computer readable medium and so executed by a computer or processor, whether or not such computer or processor is explicitly shown.

The functions of the various elements shown in the FIGS. 1 and 2, including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Their function may be carried out through the operation of program logic, through dedicated logic, through the interaction of program control and dedicated logic, or even manually, the particular technique being selectable by the implementor as more specifically understood from the context.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

We claim:

1. A method of doing business comprising:
transmitting a signal containing theatrical data, non-theatrical data and non-theatrical identification information;
receiving the signal;
modifying said signal by removing the non-theatrical data from the signal;
displaying said modified signal, with a delay, said delay determined from said non-theatrical identification information; and
charging a fee to a user for displaying the modified signal.

2. A method for viewing a transmission signal, said method comprising the steps of:
receiving the transmission signal, wherein said transmission signal contains theatrical data, non-theatrical data and non-theatrical identification information;
removing said non-theatrical data from the transmission signal; and
displaying said transmission signal without said non-theatrical data, using a playback delay, said delay determined from said non-theatrical identification information.

3. The method as recited in claim 2 further comprising the step of recording said transmission signal.

4. The method as recited in claim 2 further comprising the step of storing said removed non-theatrical data.

5. The method as recited in claim 2 wherein said non-theatrical data is selected from the group consisting of a commercial, advertising information, news information, weather information, and traffic messages.

6. The method as recited in claim 2 wherein said non-theatrical identification information includes a time period for each non-theatrical data in said transmission signal.

7. An apparatus for viewing a transmission signal, said apparatus comprising:
a processor for (1) receiving the transmission signal, wherein the transmission signal contains theatrical data, non-theatrical data and non-theatrical identification information, (2) processing said transmission signal by removing the non-theatrical data from the transmission signal and incorporating a playback delay, wherein the playback delay is determined using the non-theatrical identification information;
a memory which enables storage of the processed transmission signal; and
a display which enables viewing of the processed transmission signal data.

8. The apparatus as recited in claim 7 wherein the non-theatrical data is selected from the group consisting of a commercial, advertising information, news information, weather information, and traffic messages.

9. The apparatus as recited in claim 7, wherein the memory enables storage of the non-theatrical data.

10. The apparatus as recited in claim 7, wherein the processor further includes accounting for the number of processed transmission signals that are processed for a user.
